(19) United States
(12) Patent Application Publication
(10) Pub. No.: US 2025/0348801 A1
(43) Pub. Date: Nov. 13, 2025

(54) COMPUTER-IMPLEMENTED METHOD, AND A SERVER

(71) Applicant: GRABTAXI HOLDINGS PTE. LTD., Singapore (SG)

(72) Inventors: Nan ZHANG, Singapore (SG); Sun CHANG, Singapore (SG); Yibo JI, Singapore (SG); Shao-Heng TAI, Singapore (SG); Zijian TANG, Singapore (SG); Yik Shuen YOW, Wilayah Persekutuan (MY)

(21) Appl. No.: 19/194,869

(22) Filed: Apr. 30, 2025

(30) Foreign Application Priority Data
May 8, 2024 (SG) 10202401324S

(51) Int. Cl. G06Q 10/04; G06Q 10/02; G06Q 50/43; H04W 4/029

(52) U.S. Cl. CPC G06Q 10/043; G06Q 10/02; G06Q 50/43; H04W 4/029

(57) ABSTRACT

A system 100 comprising: a communication server 102; at least one user communication device 104 having an associated user and configured to initiate a booking which includes a booking pickup location; at least one driver communication device 106 having an associated driver vehicle and configured to provide driver vehicle location data; and communication network equipment 108 configured to establish communication with the communications server 102, the at least one user communication device 104, and the at least one driver communication device 106; wherein the communications server 102 comprises at least one processor(s) 116, at least one memory 118, the server 102 being configured, under control of one or more of the at least one processor(s) 116, to execute instructions stored in one or more of the at least one memory 118 to: cluster the proposed booking locations and driver vehicle locations into batches according to an estimated time of arrival between each vehicle and adjacent proposed bookings; cluster a respective batch into further batches if the respective batch has a number of bookings over a predetermined threshold, and allocate the proposed bookings and the available vehicles within each batch separately. A method, a server and various devices are also disclosed.

### CROSS REFERENCE

The present invention application is a non-provisional U.S. patent application claiming benefit of and priority to Singapore patent application Ser. No. 10202401324S, which was filed on May 8, 2024, the contents of which is incorporated by reference herein in its entirety.

### TECHNICAL FIELD

The invention relates generally to the field of logistics and/or transport. One aspect of the invention relates to a computer-implemented method. Another aspect of the invention relates to a server.

### BACKGROUND

In terms of logistics, it may be useful to optimise available delivery vehicles amongst a number of concurrent orders. The optimum allocation may involve allocating a number of pickup location and drop off points for a single delivery vehicle to ensure the most efficient outcome overall.

In terms of transport, it may be useful to optimise available transport vehicle amongst a number of concurrent passengers. The optimum allocation may involve including a number of nearby transport vehicles and passengers together in a batch, and then solving the optimum allocation to minimise the waiting time for transport vehicles to reach passengers.

In order to achieve the optimum allocation, it may be necessary to divide a geographic territory into smaller areas in order to reduce the computational complexity for real time allocation and to reduce any latency in allocating vehicles. There is an inherent compromise in reducing the size of the pool of candidates to form batches to reduce latency and/or computational complexity, compared to the overall efficiency of the optimisation.

Prior art attempts to resolve this have involved a periodically updated, static division of the geographic territory into zones for batching. This periodic pre-zoning may be based on historical transaction density, so that each zone has roughly the same number of expected transactions. The computational requirement for analysing the historical transactions is significant and may introduce significant inefficiencies when the real time data is inconsistent with the historical transaction data. For example at a peak time a zone in the CBD may have much more transactions than on average for the time period over which the historical transactions were complied.

It may be desirable to provide a more effective or efficient solution in some applications.

### SUMMARY

Embodiments may be implemented as set out in any of the independent claims. Some optional features are defined in the dependent claims.

Implementation of the techniques disclosed herein may provide significant technical advantages. Advantages of one or more aspects may include one or more of the following:
Reduces the likelihood of racing conditions, which is a situation where a single driver is concurrently assigned to multiple bookings. For example, in prior art systems, if two nearby bookings are divided into two different zones by sharding, each divided zone may be processed in parallel, they might share the same candidate drivers and two bookings may be assigned to the same driver during assignment. This causes the racing condition, as one driver can only receive one booking.
Reduces Global Batch Clearing (GBC) fallback. In prior art systems bookings may be accumulated for a certain period of time, and then fetch all of their candidate drivers and make assignment decisions to achieve global optimum. However, a fallback situation may exist where there is a high number of bookings but low sharding depth (i.e., we cannot categorise bookings into many smaller groups), this could result in too many bookings in one zone after sharding. Prior art systems may have an upper limit on the number of bookings that can be processed in one request. When the upper limit is breached, the prior art system may fallback to a simpler strategy such as Batch Clearing (BC) where bookings are assigned to the nearest driver, instead of the GBC strategy.
Removes the boundary of enablement GBC for new cities. The boundary here refers to the geographical area where GBC is activated.
The technical solution of faster processing of orders based on the technical problem of inaccurate pre-zoning of a geographic territory.
The technical solution of reduction in the amount of communication traffic due to less cancelled orders based on the technical problem of inaccurate pre-zoning of a geographic territory.
The technical solution of reduced data centre energy requirements based on the technical problem of inaccurate pre-zoning of a geographic territory. Particularly if the periodically updated, static division of the geographic territory into zones for batching can be avoided all together.
The technical solution of reduced greenhouse emissions based on the technical problem of inaccurate pre-zoning of a geographic territory. Because the orders are limited to those with the lowest estimated time of arrival, there may be less wasted trips by drivers, or less wasted sales by merchants, and therefore greenhouse emissions for any unnecessary trips or unnecessary product manufacturing may be avoided.
The technical solution of reduced data centre storage requirements based on the technical problem of inaccurate pre-zoning of a geographic territory. Particularly if the periodically updated, static division of the geographic territory into zones for batching can be avoided all together.
The technical solution of reduced estimated time of arrival (ETA) for a given territory based on the technical problem of inaccurate pre-zoning of a geographic territory.
The technical solution of improved transport experience by allowing drivers to arrive at customers at the minimum amount of time, avoiding waiting time for the customer and/or long travel times for the driver, based on the technical problem of inaccurate training data.
The technical solution of improved data quality and accuracy, based on the technical problem of inaccurate pre-zoning of a geographic territory.
The technical solution of reduced server hardware required for the technical problem of inaccurate pre-zoning of a geographic territory. Reduced greenhouse emissions may result from less manufacturing of hardware.
The technical solution of reduced bandwidth requirements based on the technical problem of inaccurate pre-zoning of a geographic territory. Reduced greenhouse emissions may result from less communications bandwidth requirements.
The technical solution of less latency for the technical problem of inaccurate pre-zoning of a geographic territory.

In an exemplary implementation, the functionality of the techniques disclosed herein may be implemented in software running on a handheld communications device, such as a mobile phone. The software which implements the functionality of the techniques disclosed herein may be contained in an “app”—a computer program, or computer program product-which the user has downloaded from an online store. When running on the, for example, user's mobile telephone, the hardware features of the mobile telephone may be used to implement the functionality described below, such as using the mobile telephone's transceiver components to establish the secure communications channel.

In an exemplary implementation, the functionality of the techniques disclosed herein may be implemented in software running on a server communication apparatus (such as a one or more servers, one or more virtual machines, one or more processors or a cloud computing platform), which communicates with the applications running on the user terminals, driver terminals and/or merchant terminals such as mobile phones. The software which implements the functionality of the techniques disclosed herein may be contained in a computer program, or computer program product. The server communication apparatus establishes secure communication channels with the driver, merchant and/or user terminals, for allocating users and/or merchants to drivers.

### BRIEF DESCRIPTION OF THE DRAWINGS

The invention will now be described, by way of example only, and with reference to the accompanying drawings in which:

FIG. 1 is a schematic block diagram illustrating an exemplary delivery/transportation service.

FIG. 2 is a schematic block diagram illustrating an exemplary communications server for the delivery/transportation service.

FIG. 3 is a map of distributed bookings and available drivers in a territory over a set time window.

FIG. 4 is a schematic diagram of a booking allocation system used by an Allocation Engine (AE).

FIG. 5 is a listing of sharding files.

FIG. 6 is a map diagram of a first depth of sharding.

FIG. 7 is a map diagram of a third depth of sharding.

FIG. 8 is a map diagram of a seventh depth of sharding.

FIG. 9 is a schematic diagram of sharding files.

FIG. 10 is a graph of GBC fallback overload.

FIG. 11 is a schematic diagram of a booking allocation system according to an example embodiment.

FIG. 12 is a schematic diagram of disconnecting clusters.

FIG. 13 is a schematic diagram of using an adjusted greedy Depth-first search (DFS) according to an example embodiment

### DETAILED DESCRIPTION

The techniques described herein are described primarily with reference to use in allocating bookings to vehicles. This may be useful to optimise overall efficiency.

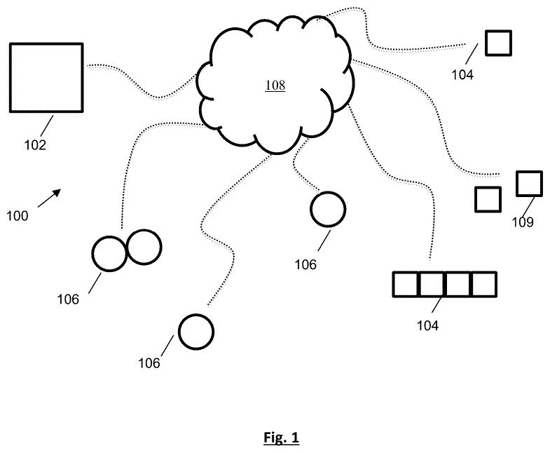

FIG. 1 shows an exemplary architecture of a system 100, with a number of users each having a communications device 104, a number of merchants each having a communications device 109, a number of drivers each having a user interface communications device 106, a server 102 (or geographically distributed servers) of a delivery platform provider and communication network 108 connecting each of the components. Each user contacts the server 102 using a user software application (App) on the communications device 104. Similarly, the drivers and merchants may use an app on their devices 106, 109.

A platform provider may use the system 100 for the purpose of logistics and/or transport management. This may involve deliveries or e-commerce-based transactions, where a customer orders some food, a product, or other physical item needing delivery. This may involve transportation, where multiple adjacent customers may order a vehicle, where one vehicle is then shared to transport each customer to multiple adjacent destinations, or where each customer has their own vehicle. Typically, the system 100 used by the platform operator will facilitate transactions between the users, and goods or services providers such as drivers or merchants. The system 100 may then be used to simultaneously optimise the allocation of available vehicles (including different applicable vehicle types) for transport of orders and/or passengers.

For deliveries or e-commerce-based transactions, the user device 104 may allow the users to input queries containing the keywords for the items of interest and delivery addresses. The user may see a list of merchants and/or items provided by the merchants, and order items from the merchants. The merchant may contact the server 102 using the merchant device 109 for providing information about their items and receiving orders for each confirmed transaction. The driver contacts the server 102 using the driver device 106. The driver device 106 allows the drivers to indicate their availability to take the delivery jobs, information about their vehicle, their location. The server 102 may then match drivers to the delivery, based on, for example: geographic location of merchants and drivers, maximising revenue, user or driver feedback ratings, weather, driving conditions, traffic level/accidents, relative demand, environmental impact, and/or supply levels. The user may be offered a particular delivery cost and approximate delivery ETA. If the user accepts the offer, the server 102 may go through a payment authorisation process. If the authorisation is approved, the merchant will then be notified and directed to provide goods for the driver to pick up. The selected driver will then be notified and directed to the pickup location to pick up the goods. The driver may be optimised to pick up goods from several merchants and drop off the series of orders in a single efficient path. During the delivery, the user device 104, the driver's device 106, the merchant's device 109 and the server 102 may be updated with real-time trip information including the real-time location of the driver's vehicle, the destination, the driver fare and/or other trip-related information. After the trip the driver's device 106 may send a confirmation that the trip has ended to server 102. Once the transaction is approved and/or the delivery is completed, the user device 104, the driver's device 106, the merchant's device 109 and the server 102 may be updated with details of the completed financial transaction. This allows an efficient allocation of resources because the available fleet of drivers is optimised for the users' demand in each territory.

For transportation, the user device 104 may allow the user to enter their pickup location, a destination address, one or more service parameters, and/or after-ride information such as a rating. The one or more service parameters may include the number of seats of the vehicle, the style of vehicle, level of environmental impact and/or what kind of transport service is desired. Each driver contacts the server 102 using a driver app on the communication device 106. The driver app allows the driver to indicate their availability to accept jobs, information about their vehicle, their location, and/or after-ride info such as a rating. The server 102 may then match users to drivers, based on, for example: geographic location of users and drivers, maximising revenue, user or driver feedback ratings, weather, driving conditions, traffic level/accidents, relative demand, environmental impact, and/or supply levels. The user may be offered a particular transport cost, or a range based on different types of vehicles, and an approximate ETA. If the user accepts the offer, the system may go through a payment authorisation process. If the authorisation is approved, the selected driver will then be notified and directed to the pickup location to pick up the user/passenger. This may be optimised for several users wishing to share a vehicle to lower the trip cost, or single vehicles. During the trip, the user device 104, the driver's device 106, and/or the server 102 may be updated with real-time trip information including the real-time location of the driver's vehicle, the destination, the trip fare and/or other trip-related information. At the conclusion of the trip, the driver's device 106 may send a confirmation the trip has ended to server 102. Once the transaction is approved and/or trip completed the user device 104, the driver's device 106, and/or the server 102 may be updated with details of the completed financial transaction. This allows an efficient allocation of resources because the available fleet of drivers is optimised for the users' demand in each territory.

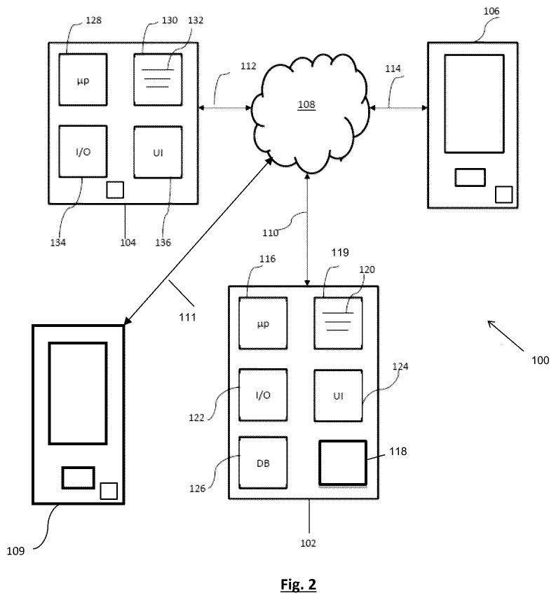

Referring to FIG. 2, further details of the components in the system of FIG. 2 are now described. The communication apparatus 100 comprises the communication server 102, and it may include the user communication device 104, the merchant communication device 109 and the driver communication device 106. These devices are connected in the communication network 108 (for example, the Internet) through respective communication links 110, 111, 112, and 114 implementing, for example, internet communication protocols. The communication devices 104, 106 and 109 may be able to communicate through communication networks and/or protocols, including cellular communication networks, LAN, WAN, private data networks, VPN, fibre optic connections, laser communication, microwave communication, satellite communication, Bluetooth, Wifi, NFC, etc., but these are not specified in FIG. 2 for the sake of clarity.

In the example shown in FIG. 2, the communication server apparatus 102 may comprise several individual components including, but not limited to, one or more microprocessors 116, one or more memories 118 (e.g., a volatile memory such as a RAM), and/or longer-term, non-volatile, or persistent, memory 119 (e.g., SSD (Solid State Drive) or Hard disk drives (HDD)) for the loading of executable instructions 120, the executable instructions defining the functionality the server apparatus 102 carries out under the control of the microprocessor 116. The communication server apparatus 102 also comprises one or more input/output modules 122 allowing the server to communicate over the communication network 108. One or more user interfaces 124 are provided for administrator control and may comprise, for example, computing peripheral devices such as display monitors, computer keyboards and the like.

The communication server apparatus 102 may be a single server as illustrated schematically in FIG. 2. Alternatively, the functionality performed by the server apparatus 102 may be distributed across multiple physically or logically separate server components. In the context of the present specification, “a server”, “the server” or “said server” is a computer program that is running on appropriate hardware and is capable of receiving requests (e.g., from electronic devices) over a network, and carrying out those requests, or causing those requests to be carried out. The hardware may be implemented as one or more physical computers, one physical computer system, one or more virtual machines, or a cloud-based server network. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers. The same approach is to be taken for references to other systems, software or hardware components e.g., processor, memory, storage etc.

Here the transactions referred to may be payments done for anything the platform provider offers, for e.g., ride-hailing, ride-sharing, food delivery, e-commerce deliveries, etc. Transactions can include any interaction where a user, driver or merchant has to pay to the platform provider for its services or products, request transportation, accept orders or deliveries, or otherwise communicate with the platform provider.

The server apparatus 102 may also comprise one or more databases 126 stored in volatile memory 118 and/or non-volatile memory 119, for storing data, which may include data on merchant behaviour, geographic information, images, products, points of interest, users, drivers, merchants, transaction data, aggregated data or parameters, payment data, and other relevant data. The data may be stored in a data structure according to the requirements of the application, or as described in more detail below. The database 126 may be replicated, distributed, sharded or otherwise optimised according to the requirements of the application.

The user communication device 104 may comprise several individual components including, but not limited to, one or more microprocessors 128, a memory 130 (e.g., a volatile memory such as RAM), and/or longer-term memory such as flash memory or SSD (Solid State drives) for the loading of executable instructions 132, the executable instructions defining the functionality the user communication device 104 carries out under the control of the microprocessor 128. The user communication device 104 also comprises an input/output module 134 allowing the user communication device 104 to communicate over the communication network 108. A user interface 136 is provided for user control. If the user communication device 104 is, say, a smartphone or tablet device, the user interface 136 will have a touch panel display as is prevalent in many smartphones and other handheld devices. Alternatively, if the user communication device 104 is, say, a desktop or laptop computer, the user interface 136 may have, for example, computing peripheral devices such as display monitors, computer keyboards and the like.

The merchant communication device 109 may be, for example, a smartphone or tablet device with the same or a similar hardware architecture to that of the user communication device 104.

The driver communication device 106 may be, for example, a smartphone or tablet device with the same or a similar hardware architecture to that of the user communication device 104. Alternatively, the functionality may be integrated into a bespoke device such as a taxi fleet management terminal or other logistics terminals.

The driver mentioned above may also be implemented by a remote driver or an autonomous driver. Examples include autonomously driven vehicle, UAVs, and drones. In that case the merchant may be responsible for loading the order with the delivery vehicle, or that task may be automated as well.

Thus, it will be appreciated that FIGS. 1 and 2 and the foregoing description illustrate and describe a system 100 comprising:
a communication server 102;
at least one user communication device 104 having an associated vehicle location; and
at least one driver communication device 106 having an associated proposed booking location and/or pickup location;
communication network equipment 108 configured to establish communication with the communications server 102, the at least one user communication device 104, and the at least one driver communication device 106;
wherein the communications server 102 comprises at least one processor, and at least one memory 118, the server being configured, under control of one or more of the at least one processor 116, to execute instructions stored in one or more of the at least one memory 118 to:
   cluster the proposed booking locations and available vehicle locations into batches according to an estimated time of arrival between each available vehicle location and adjacent proposed booking location;
   cluster a respective batch into further batches if the respective batch has a number of bookings over a predetermined threshold, and
   allocate the proposed bookings and the available vehicles within each batch separately.

Further, it will be appreciated that FIG. 11 illustrates and describes a method performed in a communication server apparatus 102, the method comprising, under control of a microprocessor 116 of the communication server apparatus 102:
receiving real-time data relating to proposed booking locations and available vehicle locations over a geographic territory;
clustering the proposed booking locations and available vehicle locations into batches according to an estimated time of arrival between each available vehicle location and adjacent proposed booking location;
clustering a respective batch into further batches if the respective batch has a number of bookings over a predetermined threshold, and
allocating the proposed bookings and the available vehicles within each batch separately.

### Dividing a Geographic Territory to Allocate Bookings

Sharding or dividing may be used to split large numbers of booking-driver pairs across a geographic territory for logistics. The geographic territory may be a city for example. It would normally be too high a computational requirement to do the optimisation over an entire system in Realtime. So, dividing the territory first allows the allocation for each division to be reduced to more manageable chunks for the optimisation algorithm. This may be done to avoid an Allocation Engine (AE) overloading and causing latency, errors, a higher than necessary hardware requirement, or reduced network efficiency.

For example, during the peak hours, a platform provider may have millions of bookings appearing during a set time window to match or allocate bookings to vehicle. This can be illustrated by the map 300 of distributed bookings and available drivers in a territory over a set time window in FIG. 3. For example, if the window is a 5 seconds time period:
A reasonably resourced AE cannot process such a large batch contains all bookings and drivers
The booking-driver pairs need to be divided into multiple batches so that AE can process each concurrently within reasonable resource constraints.

Each booking may relate to a user wanting to be transported from a pickup location to a destination. Alternatively, or additionally, each booking may relate to a user or a merchant wanting to transport an order from a pickup location to a destination

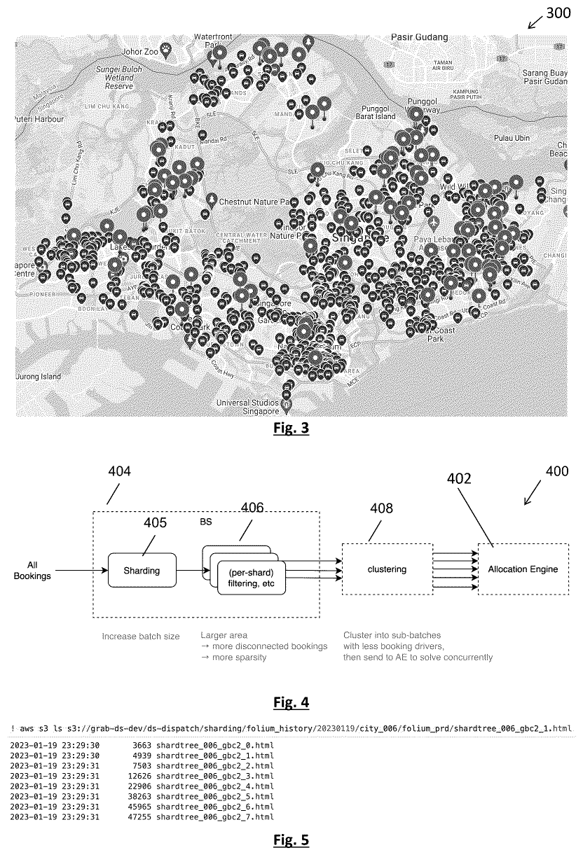

FIG. 4 shows an example process 400 used by an AE 402. The process 400 is based on a periodically updated, static division or pre-zoning of the geographic territory into zones for batching. This pre-zoning may be updated bi-weekly using historical booking data that splits areas in half with equal number of bookings statistically. For each territory or city, a number of static shading files with different depths may be used for a booking. An example listing of sharding files is shown in FIG. 5, where each sharding file is a json file where the keys are the index of the shard and the values are the geohash6 included in the index.

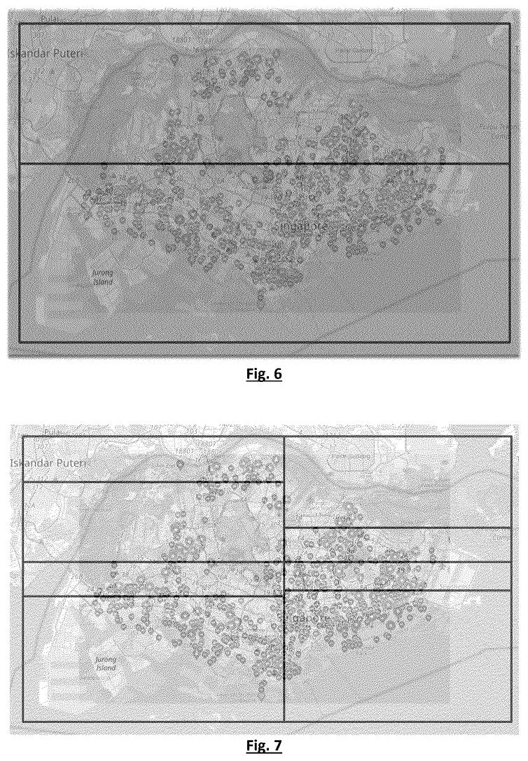

A Booking System (BS) 404 starts from the most shallow sharding file to separate the booking-driver pairs and evaluate 405 if the number of booking-drivers in the current batch exceeds the AE capacity. The AE capacity can be determined manually and may for example be set at 100 bookings per batch. If this condition is met, BS 404 will gradually reach the deeper levels of sharding file to further split bookings within the target areas. Different levels of sharding are illustrated as in FIGS. 6 to 8 respectively. This is designed so that the number of bookings within each shard are “typically” evenly distributed.

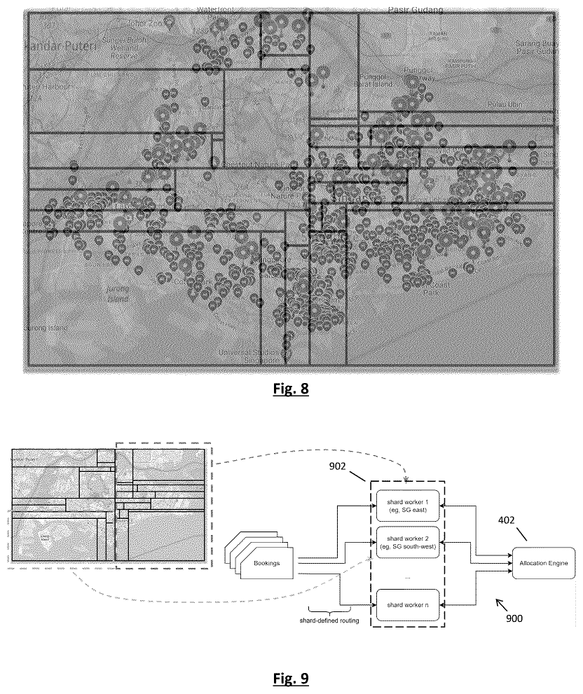

Once the level of sharing 405 is determined for a given time window, each shard, zone or division is processed by the independent shard workers 902, as shown in the schematic diagram 900 of FIG. 9. Each shard worker is a different processor (computation units) in parallel computing and can be processed concurrently in the AE 402. Each shard worker 902 implements a filtering process 406 (per shard) to select driver candidates based on a sequence of specific criteria, so that only eligible drivers are included for the allocation. Examples of specific criteria for eligibility include drivers that are close to completing their jobs, drivers with sufficient cash for certain job type (e.g., drivers who own a car are more suitable for long distance jobs as compared to drivers who own a bicycle) and drivers with faster vehicles for jobs that involve travelling long distances. Further, clustering 408 is then performed within each shard to split the graph based on the number of connected components it contains. The end result is that each pre-zone shard is divided in real time into clusters for each set time window. Each cluster is then sent to the AE 402 for independently allocating bookings to drivers within that clusters. This allows all of the simultaneous bookings to be allocated within an acceptable time period using reasonable computational resources.

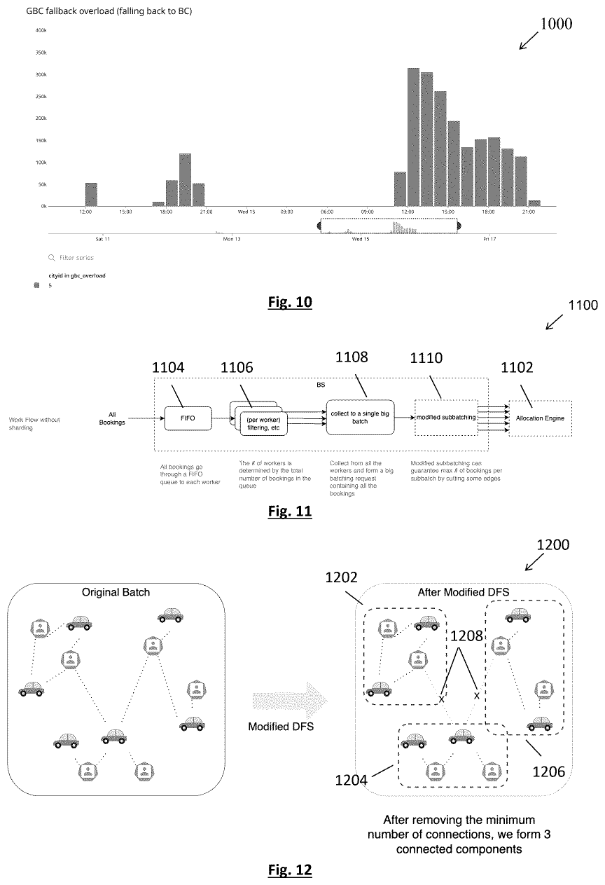

However, this may nevertheless cause problems including one or more of:
Static sharding file generation may require a large computational effort
   One run may take around 24 hours to complete
   After generating the files, a candidate system that prepares eligible booking candidate pairs for allocation may still take 2 days to load the changes
Static sharding file causes racing conditions as they don't consider the actual booking-driver links
   One driver is allocated to two bookings in two adjacent batches because the driver happens to be around the edge of the sharding boundary.
Static sharding file cannot capture dynamic online supply demand changes
   Causing the GBC fallback to BC and assignment because it reaches the maximum depth, as illustrated by graph 1000 of GBC fallback overload in FIG. 10
Static sharding file cannot fully maximize the network efficiency in GBC due to the hard splitting without considering connections

### Modified Sub-Batching

In order to develop an online approach to dynamically separate the large number of bookings-driver pairs across the territory without impacting the original booking-driver connections, according to one example embodiment, the static sharding or pre-zoning in FIG. 4 may be removed from the BS 404 processing. This may involve getting information on each candidate booking and going through filtering ahead of any batching or clustering. It may also involve an online clustering approach to dynamically generate non-connected batches.

Referring now to FIG. 11, an example process 1100 used by an AE 1102 is shown. In this case, a FIFO queue 1104 is used to allocate each booking to a BS worker 1106. Each BS worker does the following:
1. Find nearby candidates according to the pickup location and driver distances to the pickup location
2. Call various services to gather booking driver information: ETA, commission, driver favourite locations etc.
3. Aggregate the booking driver information to a batch request and send to AE 1102 for allocation

The number of BS workers 1106 is determined by the number of bookings in the queue. The computational resource is dynamic. For example, it may increase the number of workers during peak hour. A single large batch is formed 1108 from all of the bookings within the set time window. Then the modified Depth-first search (DFS), described below, is used to cluster the single large batch into sub-batches, which are then sent to the AE 1102 for optimised allocation.

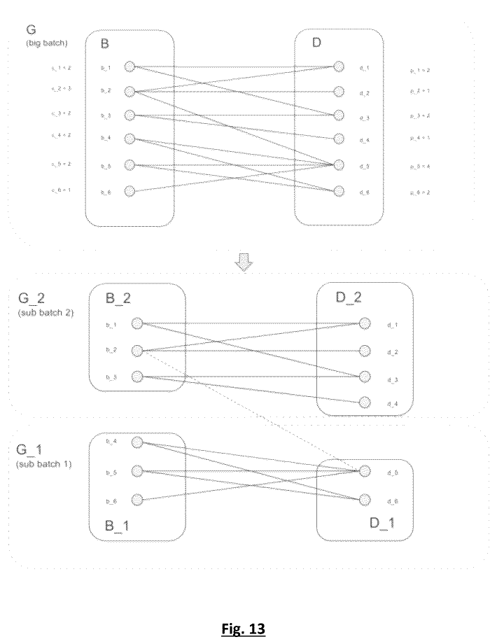

This may involve:
using the modified Depth-first search (DFS) to form an initial set of batches or clusters. The computational time may grow linearly with the number of booking driver pairs.
The modified DFS method takes in the big batch that includes all the booking driver pairs in the territory and a predetermined parameter that specifies the maximum number of bookings per batch.
The modified DFS disconnects any batch into smaller sub-batches 1202, 1204, 1206 if the predetermined parameter size is breached with minimum impact on the overall connectivity 1208 of the sub-batches as illustrated by the schematic diagram 1200 of disconnecting clusters in FIG. 12.

### Initial Modified Depth-First Search (DFS)

The following list provides the definitions of notations which will be used in describing the examples below:
B: the set of nodes that represent the bookings.
D: the set of nodes that represent the drivers.
E: the set of edges that represent the booking driver pairs that are connected (i.e. driver is eligible candidate of the booking)
G(B, D, E): the graph that consists of node sets B, D and edge set E
G_s(B_s, D_s, E_s): the graph representing the subbatch s for s=1, 2, 3, . . .
B_s: the set of nodes that represent the bookings in subbatch s for s=1, 2, 3, . . .
D_s: the set of nodes that represent the drivers in subbatch s for s=1, 2, 3, . . .
E_s: the set of edges that represent the booking driver pairs that are connected in subbatch s for s=1, 2, 3, . . .
n: maximum number of bookings (size (B)) allowed in one sub graph
b_i: the booking node in B for i=1, 2, 3, . . .
d_j: the driver node in D for j=1, 2, 3, . . .
c_i: the number of drivers connected to the booking b_i for i=1, 2, 3, . . .
p_j: the number of bookings connected to the driver d_j for j=1, 2, 3, . . .
eta_ij: the estimated time of arrival (ETA) between booking b_i and driver d_j

We use an adjusted greedy DFS to achieve a feasible solution (no optimal guaranteed). Given a bipartite graph G(B, D, E), B representing the set of bookings, D representing the set of drivers, E representing the booking-driver pairs that are eligible, each edge has a weight=eta. We then optimise to find the minimum number of edges in E to cut in order to form a new graph G′(B, D, E′) with the maximum connected component of size n.

For example:
1. Calculate the index c_i for each b_i in B and the index p_j for each d_j in D.
2. Traverse along the graph and collect the subgraph G_s (B_s, D_s, E_s):
   a. Start the search from the b_i with minimum c_i, then collect b_i into B_s.
   b. Check all drivers connected to b_i and go to d_j in D-D_s with the minimum p_i, then collect d_j into D_s.
   c. Check all bookings connected to d_j and go to b_i in B-B_s with minimum b_i, then collect b_i into B_s. Repeat step 2b until we reach stopping condition.
   d. Suppose 2 bookings b_1 and b_2 are connected to the driver d_1 with the same index value, i.e., c_1 =c_2. Then, choose the one with smaller ETA, i.e., if eta_11 <eta_21, then we collect b_1.
   e. In other words, at the beginning, we order the bookings according to its connectivity (ETA is measured by ETA, but this may be adapted according to the requirements of the application), and the allocation starts from the smallest ETA.
3. There are 2 stopping conditions:
   a. If we have not completed the DFS and collected n bookings already, we need to cut some connections between nodes inside the subbatch and the remaining nodes in the big batch:
      i. After we collected the last booking, use DFS that finds all the drivers that are in D-D_s that is the end of the path, including those drivers in D_s. Disconnect those drivers with the bookings outside of the subbatch.
      ii. For each driver connected to the last booking (we record all the bookings that have been put into smaller batches, so the last booking is the last one in the big batch that has not been processed), if the booking connected to this driver is not connected to any other driver and this driver is not included in D_s yet, remove this driver from the current collection D_s.
   b. If we have completed the DFS but have not reached the maximum booking number n, stop without cutting connection.
4. Once the stopping conditions are met, collect B_s and D_s as one batch. Remove all the bookings in B_s and D_s, and disconnect all other bookings and drivers in the remaining batch with those in the sub batch. Set B=B−B_s, D=D_s, E=E′, where E′ is the edge set that connects the remaining booking and drivers. Repeat from step 3 until all the b_i in B are processed.

The output of the adjusted greedy DFS is a series of Splitted_batches each containing a set of: {sub_batch_id: sub_batch}.

An exemplary embodiment of this can be illustrated in FIG. 13. In this example, we have a graph of 6 bookings and 6 drivers. Maximum number of bookings in a batch is set at 3 (n=3). We can follow the algorithm to split this graph into 2 sub-batch.

The table of ETA in seconds is shown as follows:

| eta_ij | d_1 | d_2 | d_3 | d_4 | d_5 | d_6 |
|---|---|---|---|---|---|---|
| b_1 | 100 | NA | 150 | NA | NA | NA |
| b_2 | 200 | 100 | NA | NA | 150 | NA |
| b_3 | NA | NA | 100 | 200 | NA | NA |
| b_4 | NA | NA | NA | NA | 100 | 200 |
| b_5 | NA | NA | NA | NA | 200 | 100 |
| b_6 | NA | NA | NA | NA | 250 | NA |

Calculate c_i for each b_i and p_j for each d_j for each booking and driver.

Travel the graph based on the index value:
a. Start with b_6 having the lowest c_6 =1, collect b_6 into our first subbatch B_1.
b. Move to d_5 which is connected to b_6, collect d_5 into D_1.
c. There are 4 bookings connected to d_5, namely, b_2, b_4, b_5, b_6. Since b_6 is already in B_1, we will only check b_2, b_4, b_5. The minimum value of the index is 2 and c_4 =c_5 =2. Since there are 2 bookings with the same minimum index value, we will choose the booking that has a smaller ETA to the driver. Since eta_45 =100 <eta_55 =200, we choose b_4 as the next booking and thus, collect b_4 into B_1.
d. The booking b_4 is connected to d_5 and d_6, but only d_6 is not in D_1. Thus, collect d_6 into D_1.
e. There are 2 bookings b_4 and b_5 connected to d_6, but only b_5 is not in B_1. Thus, collect b_5 into B_1.

The stopping criteria is met and we have collected 3 bookings into B_1, namely, b_6, b_5, b_4. Using DFS, we found that all the drivers are connected to d_5 and d_6. Thus, the first subbatch collection will be stopped by cutting the connection between d_5 and b_2.

After removing G_1 (B_1, D_1, E_1) from the big batch G, we can repeat the steps above, starting from step 2, to find the next subbatch G_2 (B_2, D_2, E_2). After completion, we will achieve 2 sub batches by disconnecting d_5 and b_2. This is also illustrated in FIG. 13, where the disconnection between d_5 and b_2 is shown by the dotted line.

### Test Results: Static Sharding vs Online Sharding

To compare the effects between Static Sharding (FIG. 4) and Online Sharding (FIG. 11), we used a historical dataset of ride hailing bookings from Bangkok (BKK) and Singapore (SG) to run comparison tests.

The table below shows the comparison test results of Static Sharding vs Online Sharding:

| | | Before | Static | Online | Percentage |
|---|---|---|---|---|---|
| | | Sharding | Sharding | Sharding | change (%) |
| | | BKK | | | |
| Morning | Number of batches | — | 3 | 26 | 88 |
| Peak | Average number of | 4018 | 1340 | 155 | −765 |
| | booking_driver | | | | |
| | Allocation Rate | — | 76.2% | 76.9% | 0.7 |
| | Number of racing | — | 1 | 0 | −100 |
| | conditions | | | | |
| Lunch | Number of batches | — | 8 | 40 | 80 |
| Peak | Average number of | 3654 | 457 | 92 | −397 |
| | booking_driver | | | | |
| | Allocation Rate | — | 70.7% | 72.4% | 2.4 |
| | Number of racing | — | 5 | 0 | −100 |
| | conditions | | | | |
| Evening | Number of batches | — | 6 | 21 | 71 |
| Peak | Average number of | 2583 | 430 | 123 | −250 |
| | booking_driver | | | | |
| | Allocation Rate | — | 88% | 92% | 4 |
| | Number of racing | — | 5 | 0 | −100 |
| | conditions | | | | |
| | | SG | | | |
| Morning | Number of batches | — | 3 | 5 | 40 |
| Peak | Average number of | 2405 | 921 | 481 | −91 |
| | booking_driver | | | | |
| | Allocation Rate | — | 69% | 75% | 6 |
| | Number of racing | — | 0 | 0 | 0 |
| | conditions | | | | |
| Lunch | Number of batches | — | 9 | 27 | 67 |
| Peak | Average number of | 2111 | 235 | 78 | −201 |
| | booking_driver | | | | |
| | Allocation Rate | — | 27.2% | 27.2% | 0 |
| | Number of racing | — | 0 | 0 | 0 |
| | conditions | | | | |
| Evening | Number of batches | — | 12 | 22 | 45 |
| Peak | Average number of | 957 | 90 | 44 | −105 |
| | booking_driver | | | | |
| | Allocation Rate | — | 39% | 46% | 7 |
| | Number of racing | — | 2 | 0 | −100 |
| | conditions | | | | |

The comparison test results show that Online Sharding results in an increase in the number of batches formed. The average number of booking driver pairs formed is calculated by taking the average number of booking driver pairs before sharding and dividing it by the number of batches formed in Static and Online sharding respectively. In some instances, for static sharding, a booking driver may be allocated to multiple bookings simultaneously due to racing conditions, resulting in the number of booking driver pairs to be more than the number of booking drivers available. Overall, the average number of booking driver pairs formed in Online Sharding decreases in each shard.

This, in turn, will significantly reduce AE latency from >1 s for Static Sharding (FIGS. 4) to <10 ms for Online Sharding (FIG. 11) as parallel computing can be done for multiple batch requests, allowing smaller batch AE to react faster. As such, the AE latency is linearly related to the number of booking driver pairs formed in each shard.

The allocation rate represents the number of drivers that are assigned to more than 1 booking at the same time and is calculated by dividing the number of allocated bookings by the total number of bookings. As such. online Sharding results in an increase in allocation rate as it considers bookings and drivers in the entire geographic network as compared to Static Sharding. Online sharding also eliminates racing conditions as compared to Static Sharding. In other words, online sharding ensures that a driver will not be available to two different batches, preventing any drivers from being allocated to multiple bookings simultaneously.

What is claimed is:

1. A computer implemented method performed in a communication server apparatus for a platform provider, the method comprising, under control of a processor of the communication server apparatus:
receiving real-time data relating to proposed bookings and available vehicles over a geographic territory;
clustering the proposed bookings and available vehicles into batches according to an estimated time of arrival between each vehicle and adjacent proposed bookings;
clustering a respective batch into further batches if the respective batch has a number of bookings over a predetermined threshold, and allocating the proposed bookings and the available vehicles within each batch separately.

2. The method of claim 1 wherein the clustering of the proposed bookings and available vehicles into batches is done over an entire geographic territory.

3. The method of claim 1 wherein the clustering of the proposed bookings and available vehicles into batches is done using a Depth-first search (DFS) algorithm.

4. The method of claim 1 wherein the clustering the respective batch into further batches further comprises disconnecting the respective batch into the further batches based on a level of connection between each vehicle and a pick up point for each proposed booking in the respective batch.

5. The method of claim 4 wherein the level of connection between each vehicle and pick up point is determined based on a total number of connected vehicles each pick up point contains.

6. The method of claims 4 wherein the level of connection between each vehicle and pick up point is determined based on a total number of connected pick up points each vehicle contains.

7. The method of claim 1 wherein the clustering is done without dividing the territory based on historical transactions and/or geographically pre-zoning the territory.

8. A computer program or computer program product comprising computer implementable instructions which, when run on a programmable computer device, cause the programmable computer to perform the method of claim 1.

9. A computer program carrier carrying a computer program according to claim 8, wherein the computer program carrier is one of an electronic signal, optical signal, radio signal or non-transitory tangible computer-readable storage medium.

10. A non-transitory tangible computer-readable storage medium storing a computer program according to claim 8.

11. A system comprising
a communication server;
at least one user communication device having an associated user and configured to initiate a booking which includes a booking pickup location;
at least one driver communication device having an associated driver vehicle and configured to provide driver vehicle location data; and
communication network equipment configured to establish communication with the communications server, the at least one user communication device, and the at least one driver communication device;
wherein the communications server comprises at least one processor(s), at least one memory, the server being configured, under control of one or more of the at least one processor(s), to execute instructions stored in one or more of the at least one memory to:
cluster the proposed booking locations and driver vehicle locations into batches according to an estimated time of arrival between each vehicle and adjacent proposed bookings;
cluster a respective batch into further batches if the respective batch has a number of bookings over a predetermined threshold, and allocate the proposed bookings and the available vehicles within each batch separately.

12. A communication server apparatus for a delivery platform provider, the communication server comprising at least one processor, the communication server apparatus being configured, under control of one or more of the at least one processors, to execute instructions, to:
receive real-time data relating to proposed bookings and available vehicles over a geographic territory;
cluster the proposed bookings and available vehicles into batches according to an estimated time of arrival between each vehicle and adjacent proposed bookings;
cluster a respective batch into further batches if the respective batch has a number of bookings over a predetermined threshold, and allocate the proposed bookings and the available vehicles within each batch separately.

13. A user communication device, a driver communication device, or a merchant communication device for a platform provider, the user communication device, the driver communication device, or the merchant communication device comprising a processor and a memory, the user communication device, the driver communication device, or the merchant communication device being configured, under control of the processor, to execute instructions stored in the memory, to perform the method according to claim 1.
